(19) United States
(12) Patent Application Publication
(10) Pub. No.: US 2020/0392316 A1
(43) Pub. Date: Dec. 17, 2020

(54) VULCANIZED HNBR PRODUCT WITH IMPROVED HOT AIR

(71) Applicant: ARLANXEO DEUTSCHLAND GMBH, Dormagen (DE)

(72) Inventors: Susanna LIEBER, Kaiserslautern (DE); Andreas KAISER, Düsseldorf (DE); Ulrich FRENZEL, Dormagen (DE)

(73) Assignee: ARLANXEO DEUTSCHLAND GMBH, Dormagen (DE)

(21) Appl. No.: 16/955,274

(22) PCT Filed: Dec. 11, 2018
(86) PCT No.: PCT/EP2018/084330

§ 371 Date: Jun. 18, 2020

(30) Foreign Application Priority Data
Dec. 21, 2017 (EP) 17209719.8

(51) Int. Cl. C08L 15/00; C08L 77/02; C08K 3/36; C08K 3/20; C08K 5/00; C08K 5/14; C08K 5/18; C08K 5/3437; C08K 5/36

(52) U.S. Cl. CPC C08L 15/005; C08L 77/02; C08K 3/36; C08K 3/20; C08K 2003/222; C08K 5/14; C08K 5/18; C08K 5/3437; C08K 5/36; C08K 5/0025

(57) ABSTRACT

The present invention relates to vulcanizable compositions comprising HNBR rubber, polyimide and peroxidic crosslinker, and optionally light-coloured filler and ageing stabilizer, to vulcanizates thereof and to the use thereof for production of mouldings.

The present invention relates to vulcanizable compositions comprising HNBR rubber, polyimide and peroxidic crosslinker, and optionally light-coloured filler and ageing stabilizer, to vulcanizates thereof and to the use thereof for production of mouldings.

### DESCRIPTION

Vulcanizates made from vulcanizable compositions are notable for their different hot air stability. According to a classification in accordance with ASTM-D 2000 standard, vulcanizates made of natural rubber (NR) can be used up to 70° C.; HNBR rubber has a distinctly reduced number of double bonds (typically less than 50% of the double bonds in the original NBR), which achieves, inter alia, an improvement in hot air stability up to 150° C. If an application requires even higher hot air stability, it is frequently necessary to resort to fluorinated rubbers (e.g. FKM), but this can be found to be disadvantageous both in technological and in financial terms. Thus, HNBR vulcanizates typically have better cold flexibility and better stability to basic media. By means of suitable formulations of rubber mixtures based on HNBR rubber, the intention was to find a way of further increasing hot air stability, in order thus to provide the customer with technologically and economically attractive alternatives to FKM formulations.

WO-A-2012/177879 discloses compositions composed of acrylate rubber with >40% by weight of acrylate rubber and 10% to 60% by weight of polyamide having a melting point of >160° C. There is no disclosure of compositions based on HNBR rubber.

WO-A-2014/089136 describes compositions composed of EVM (ethylene-vinyl acetate polymer), crosslinkable polyacrylate and polyamide, wherein the polyamide has a melting point of >160° C. There is no description of compositions based on HNBR rubber.

EP-A-0364859 discloses vulcanizable compositions of HNBR having a residual double bond value of less than 1% comprising polyamide (Nylon® 12; Grilamid L20G). The amount of polyamide in the vulcanizable composition is 20% to 55% by weight. An example used is HNBR rubber with 34% by weight of acrylonitrile (ACN).

EP-A-1672027 discloses a thermoplastic elastomer compositions (TPE) composed of 40 parts by weight of HXNBR containing carboxyl groups and 60 parts by weight of polyamide.

EP-A-2692788 discloses compositions comprising 20 or 30 parts by weight of polyamide (Nylon® 6 or Nylon® 12) and 70 to 80 parts by weight of highly saturated nitrile rubber and/or highly saturated nitrile rubber containing carboxyl groups.

U.S. Pat. No. 6,133,375 discloses compositions comprising rubber and thermoplastic. Examples of rubbers that may be used include NBR, XNBR or HNBR. The thermoplastic is present in an amount of 5 to 60 parts. What is particularly disclosed is a composition containing HNBR (Zetpol 2000) and a TPC consisting of polyether blocks and polyamide blocks (Pebax). There is no disclosure of the hot air ageing properties of these compositions.

The problem addressed by the present invention is that of providing a vulcanizate based on a vulcanizable composition, said vulcanizate having very good hot air stability, especially a reduced change in elongation at break and/or a reduced change in tensile strength.

The solution to the problem and the subject-matter of the present invention is thus a vulcanizable composition comprising
(a) HNBR rubber,
(b) polyamide,
(c) peroxidic crosslinker,
(d) optionally light-coloured filler and
(e) optionally ageing stabilizer,

where the ratio of (a) to (b) is 1:0.01 to 1:0.15, preferably 1:0.05 to 1:0.10.

By virtue of the vulcanizable composition according to the invention, it is already possible to provide vulcanizates that overcome the disadvantages of the prior art.

It should be noted at this point that the scope of the invention includes any and all possible combinations of the components, ranges of values, radical definitions and/or process parameters mentioned above and cited hereinafter, in general terms or within areas of preference.

The individual components of the vulcanizable composition according to the invention are detailed hereinafter.

Vulcanizable Compositions Based on HNBR Rubber

The present invention provides vulcanizable compositions comprising HNBR rubber (a), polyamide (b) and a peroxidic crosslinker (c), wherein the ratio of (a) to (b) is 1:0.01 to 1:0.15, preferably 1:0.05 to 1:0.1. A preferred embodiment concerns vulcanizable compositions that additionally contain at least one light-coloured filler (d) and/or at least one ageing stabilizer (e).

(a) HNBR Rubber

In the context of this application, “nitrile-diene copolymer” (nitrile-butadiene copolymer, nitrile rubber, also abbreviated to “NBR”) is understood to mean rubbers which are co-, ter- or quaterpolymers of at least one α,β-ethylenically unsaturated nitrile, at least one conjugated diene and optionally one or more additional copolymerizable monomers. The term thus also encompasses copolymers having two or more α,β-ethylenically unsaturated nitrile monomer units and two or more conjugated diene monomer units.

“Hydrogenated nitrile-diene copolymer” (“HNBR”) is understood to mean corresponding co-, ter- or quaterpolymers in which at least some of the C═C double bonds in the copolymerized diene units have been hydrogenated, preferably at least 50% of the C═C double bonds. In a preferred embodiment, the hydrogenated HNBR rubber is fully hydrogenated.

The term “fully hydrogenated” means that the degree of hydrogenation of the butadiene units in the hydrogenated nitrile-diene copolymer is 99.1% to 100%.

The term “copolymer” encompasses polymers having more than one monomer unit.

α,β-ethylenically unsaturated nitrile

The α,β-ethylenically unsaturated nitrile used which forms the α,β-ethylenically unsaturated nitrile units may be any known α,β-ethylenically unsaturated nitrile. Preference is given to (C₃-C₅)-α,β-ethylenically unsaturated nitriles such as acrylonitrile, α-haloacrylonitrile, for example α-chloroacrylonitrile and α-bromoacrylonitrile, α-alkylacrylonitrile, for example methacrylonitrile, ethacrylonitrile or mixtures of two or more α,β-ethylenically unsaturated nitriles. Particular preference is given to acrylonitrile, methacrylonitrile, ethacrylonitrile or mixtures thereof. Very particular preference is given to acrylonitrile.

The amount of α,β-ethylenically unsaturated nitrile units is typically in the range from 10% to 60% by weight, preferably 15% to 50% by weight, more preferably from 17% to 44% by weight, based on the total amount of 100% by weight of all monomer units in the HNBR rubber.

Conjugated Diene

The conjugated diene which forms the conjugated diene units may any conjugated diene, especially conjugated C₄-C₁₂ dienes. Particular preference is given to 1,3-butadiene, isoprene, 2,3-dimethylbutadiene, 1,3-pentadiene (piperylene), 2-chloro-1,3-butadiene or mixtures thereof. 1,3-Butadiene and isoprene or mixtures thereof are especially preferred. Very particular preference is given to 1,3-butadiene.

The amount of conjugated diene is typically in the range from 40% to 90% by weight, preferably 50% to 85% by weight and more preferably 56% to 83% by weight, based on the total amount of 100% by weight of all the monomer units in the HNBR rubber.

Further Comonomers

α,β-Ethylenically Unsaturated Carboxylic Ester Units

In addition to the α,β-ethylenically unsaturated nitrile units and the conjugated diene units, the HNBR rubber may contain at least one α,β-ethylenically unsaturated carboxylic ester unit.

Typical α,β-ethylenically unsaturated carboxylic ester units are
alkyl (meth)acrylate, especially C₄-C₁₈-alkyl (meth)acrylate, preferably n-butyl, tert-butyl, n-pentyl or n-hexyl (meth)acrylate;
alkoxyalkyl (meth)acrylate, especially C₄-C₁₈-alkoxyalkyl (meth)acrylate, preferably C₄-C₁₂-alkoxyalkyl (meth)acrylate;
hydroxyalkyl (meth)acrylate, especially C₄-C₁₈-hydroxyalkyl (meth)acrylate, preferably C₄-C₁₂-hydroxyalkyl (meth)acrylate;
cycloalkyl (meth)acrylate, especially C₅-C₁₈-cycloalkyl (meth)acrylate, preferably C₆-C₁₂-cycloalkyl (meth)acrylate, more preferably cyclopentyl (meth)acrylate, cyclohexyl (meth)acrylate, cycloheptyl (meth)acrylate;
alkylcycloalkyl (meth)acrylate, especially C₆-C₁₂-alkylcycloalkyl (meth)acrylate, preferably C₇-C₁₀-alkylcycloalkyl (meth)acrylate, more preferably methylcyclopentyl (meth)acrylate and ethylcyclohexyl (meth)acrylate;
aryl monoesters, especially C₆-C₁₄-aryl monoesters, preferably phenyl (meth)acrylate or benzyl (meth)acrylate;
amino-containing α,β-ethylenically unsaturated carboxylic esters, for example dimethylaminomethyl acrylate or diethylaminoethyl acrylate;
α,β-ethylenically unsaturated monoalkyl dicarboxylates, preferably
   alkyl monoesters, especially C₄-C₁₈-alkyl monoesters, preferably n-butyl, tert-butyl, n-pentyl or n-hexyl monoesters, more preferably mono-n-butyl maleate, mono-n-butyl fumarate, mono-n-butyl citraconate, mono-n-butyl itaconate, most preferably mono-n-butyl maleate,
   alkoxyalkyl monoesters, especially C₄-C₁₈-alkoxyalkyl monoesters, preferably C₄-C₁₂-alkoxyalkyl monoesters,
   hydroxyalkyl monoesters, especially C₄-C₁₈-hydroxyalkyl monoesters, preferably C₄-C₁₂-hydroxyalkyl monoesters,
   cycloalkyl monoesters, especially C₅-C₁₈-cycloalkyl monoesters, preferably C₆-C₁₂-cycloalkyl monoesters, more preferably monocyclopentyl maleate, monocyclohexyl maleate, monocycloheptyl maleate, monocyclopentyl fumarate, monocyclohexyl fumarate, monocycloheptyl fumarate, monocyclopentyl citraconate, monocyclohexyl citraconate, monocycloheptyl citraconate, monocyclopentyl itaconate, monocyclohexyl itaconate and monocycloheptyl itaconate,
   alkylcycloalkyl monoesters, especially C₆-C₁₂-alkylcycloalkyl monoesters, preferably C₇-C₁₀-alkylcycloalkyl monoesters, more preferably monomethylcyclopentyl maleate and monoethylcyclohexyl maleate, monomethylcyclopentyl fumarate and monoethylcyclohexyl fumarate, monomethylcyclopentyl citraconate and monoethylcyclohexyl citraconate; monomethylcyclopentyl itaconate and monoethylcyclohexyl itaconate;
   aryl monoesters, especially 06-014-aryl monoesters, preferably monoaryl maleates, monoaryl fumarates, monoaryl citraconates or monoaryl itaconates, particularly preferably monophenyl maleate or monobenzyl maleate, monophenyl fumarate or monobenzyl fumarate, monophenyl citraconate or monobenzyl citraconate, monophenyl itaconate or monobenzyl itaconate,
   unsaturated polyalkyl polycarboxylates, for example dimethyl maleate, dimethyl fumarate, dimethyl itaconate or diethyl itaconate;

or mixtures thereof.

In a particularly preferred embodiment, the fully or partly hydrogenated HNBR rubber contains a (01-04)-alkyl methacrylate, most preferably butyl acrylate.

The amount of the optional α,β-ethylenically unsaturated carboxylic ester units in the HNBR rubbers according to the invention is typically in the range from 0% to 20% by weight, preferably 0.5% to 15% by weight and more preferably 1% to 10% by weight, based on the total amount of 100% by weight of all the monomer units.

PEG Acrylate

In addition to the α,β-ethylenically unsaturated nitrile units and the conjugated diene units, the HNBR rubber may contain, as a further unit, at least one PEG acrylate unit derived from the general formula (I)

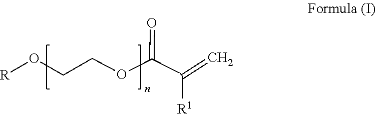

where
R is branched or unbranched C₁-C₂₀-alkyl, preferably C₂-C₂₀-alkyl, more preferably methyl, ethyl, butyl or ethylhexyl,
n is 1 to 12, preferably 1 to 8, more preferably 1 to 5 and most preferably 1, 2 or 3 and
R¹ is hydrogen or CH₃—.

The term “(meth)acrylate” in the context of this invention represents “acrylate” and “methacrylate”. When the R¹ radical in the general formula (I) is CH₃—, the molecule is a methacrylate.

The term “polyethylene glycol” or the abbreviation “PEG” in the context of this invention represents ethylene glycol sections having two repeat ethylene glycol units (PEG-2; n=2) to 12 repeat ethylene glycol units (PEG-2 to PEG-12; n=2 to 12).

The term “PEG acrylate” is also abbreviated to PEG-X-(M)A where “X” is the number of repeat ethylene glycol units, “MA” is methacrylate and “A” is acrylate.

Acrylate units derived from PEG acrylates of general formula (I) are referred to in the context of this invention as “PEG acrylate unit”.

Preferred PEG acrylate units are derived from the PEG acrylates having the following formulae no. 1 to no. 8, wherein n is 2, 3, 4, 5, 6, 7, 8, 9, 10, 11 or 12, preferably 2, 3, 4, 5, 6, 7 or 8, more preferably 2, 3, 4 or 5 and most preferably 2 or 3:

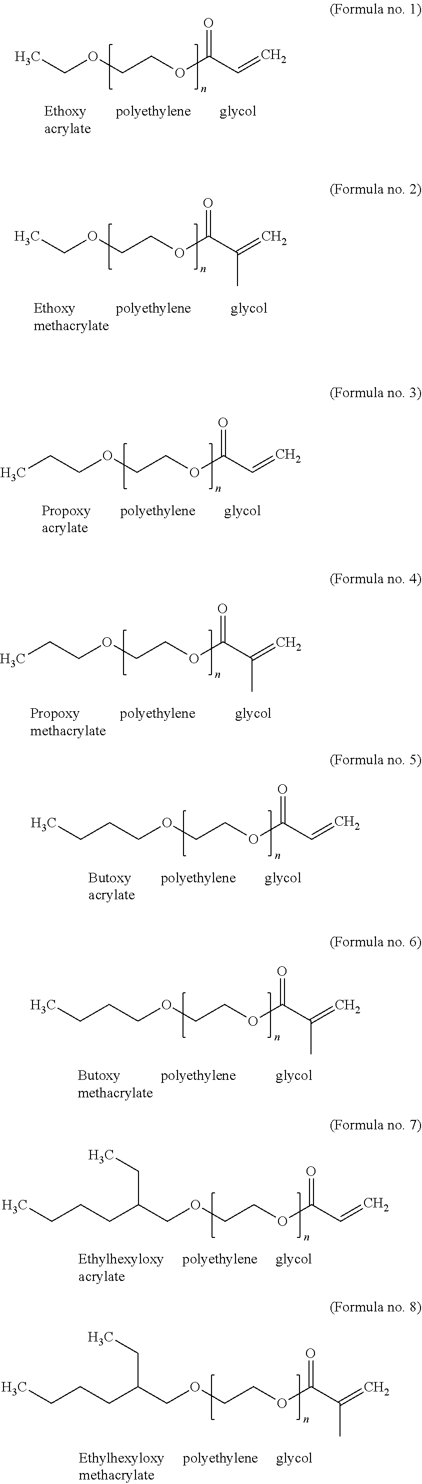

Other commonly used designations for ethoxy polyethylene glycol acrylate (formula no. 1) are for example poly(ethylene glycol) ethyl ether acrylate, ethoxy PEG acrylate, ethoxy poly(ethylene glycol) monoacrylate or poly(ethylene glycol) monoethyl ether monoacrylate.

These PEG acrylates can be purchased commercially, for example from Arkema under the Sartomer® trade name, from Evonik under the Visiomer® trade name, or from Sigma Aldrich.

The amount of the optional PEG acrylate units in the HNBR rubbers according to the invention is typically in the range from 0% to 60% by weight, preferably 20% to 60% by weight and more preferably 20% to 55% by weight, based on the total amount of 100% by weight of all the monomer units.

In an alternative embodiment, the HNBR rubber contains not only the α,β-ethylenically unsaturated nitrile unit and the conjugated diene unit as a further monomer but also a PEG acrylate unit derived from a PEG acrylate of general formula (I) and, as a further unsaturated carboxylic ester unit, a monoalkyl dicarboxylate unit, preferably monobutyl maleate.

In a preferred HNBR rubber according to the invention, the α,β-ethylenically unsaturated nitrile unit is derived from acrylonitrile or methacrylonitrile, more preferably from acrylonitrile, the conjugated diene unit is derived from isoprene or 1,3-butadiene, more preferably from 1,3-butadiene, and the optional PEG acrylate unit is derived from PEG acrylate of the general formula (I) where n is 2 to 8, more preferably from PEG acrylate of the general formula (I) where n is 2 or 3, where no further carboxylic ester unit is present.

In a further preferred HNBR rubber according to the invention, the α,β-ethylenically unsaturated nitrile unit is derived from acrylonitrile or methacrylonitrile, more preferably from acrylonitrile, the conjugated diene unit is derived from isoprene or 1,3-butadiene, more preferably from 1,3-butadiene, and the optional PEG acrylate unit is derived from PEG acrylate of the general formula (I) where n is 2 to 12, more preferably from PEG acrylate of the general formula (I) where n is 2 or 3.

In addition, the HNBR rubber, as well as the optional α,β-ethylenically unsaturated carboxylic ester units and/or optional PEG acrylate units, may contain one or more further copolymerizable monomers in an amount of 0% by weight to 20% by weight, preferably 0.1% by weight 10% by weight, based on the total amount of 100% by weight of all monomer units. In that case, the amounts of the other monomer units are reduced in a suitable manner, such that the sum total of all monomer units is always 100% by weight. The HNBR rubber may contain, as further copolymerizable monomers, one or more
aromatic vinyl monomers, preferably styrene, α-methylstyrene and vinylpyridine,
fluorine-containing vinyl monomers, preferably fluoroethyl vinyl ether, fluoropropyl vinyl ether, o-fluoromethylstyrene, vinyl pentafluorobenzoate, difluoroethylene and tetrafluoroethylene, or else
α-olefins, preferably C₂-C₁₂ olefins, for example ethylene, 1-butene, 4-butene, 4-methyl-1-pentene, 1-hexene or 1-octene,
non-conjugated dienes, preferably C₄-C₁₂ dienes such as 1,4-pentadiene, 1,4-hexadiene, 4-cyanocyclohexene, 4-vinylcyclohexene, vinylnorbornene, dicyclopentadiene or else alkynes such as 1- or 2-butyne,
α,β-ethylenically unsaturated monocarboxylic acids, preferably acrylic acid, methacrylic acid, crotonic acid or cinnamic acid,
α,β-ethylenically unsaturated dicarboxylic acids, preferably maleic acid, fumaric acid, citraconic acid, itaconic acid,
copolymerizable antioxidants, for example N-(4-anilinophenyl)acrylamide, N-(4-anilinophenyl)methacrylamide, N-(4-anilinophenyl)cinnamide, N-(4-anilinophenyl)crotonamide, N-phenyl-4-(3-vinylbenzyloxy)aniline, N-phenyl-4-(4-vinylbenzyloxy)aniline or
crosslinkable monomers, for example divinyl components such as divinylbenzene for example.

In an alternative embodiment, the HNBR rubber contains, as optional PEG acrylate units, ethoxy, butoxy or ethylhexyloxy polyethylene glycol (meth)acrylate comprising 2 to 12 repeat ethylene glycol units, more preferably ethoxy or butoxy polyethylene glycol (meth)acrylate comprising 2 to 5 repeat ethylene glycol units and most preferably ethoxy or butoxy polyethylene glycol (meth)acrylate comprising 2 or 3 repeat ethylene glycol units.

In a further alternative embodiment, the HNBR rubber includes 8% to 18% by weight of acrylonitrile units, 27% to 65% by weight of 1,3-butadiene units and optionally 27% to 55% by weight of PEG-2 acrylate units or PEG-3 acrylate units.

The most preferred HNBR rubbers contain acrylonitrile/butadiene; acrylonitrile/butadiene/(meth)acrylic acid; acrylonitrile/butadiene/butyl (meth)acrylate; acrylonitrile/butadiene/butyl maleate; acrylonitrile/butadiene/butyl itaconate; acrylonitrile/butadiene/methoxyethyl (meth)acrylate; acrylonitrile/butadiene/butoxydiglycol (meth)acrylate or acrylonitrile/butadiene/ethoxytriglycol (meth)acrylate.

The HNBR rubber according to the invention typically has a number-average molecular weight (Mn) of 10 000 g/mol to 2 000 000 g/mol, preferably 50 000 g/mol to 1 000 000 g/mol, more preferably 50 000 g/mol to 500 000 g/mol and most preferably 50 000 g/mol to 300 000 g/mol.

The HNBR rubber according to the invention typically has a polydispersity index (PDI=M_{w}/Mₙ where M_{w} is the weight-average molecular weight) of 1.5 to 6, preferably 2 to 5 and more preferably 2.5 to 4.

The HNBR rubber according to the invention typically has a Mooney viscosity (ML1+4@100° C.) of 10 to 150, preferably of 20 to 120 and more preferably of 25 to 100.

Process for Preparing Unhydrogenated Nitrile-Diene Copolymers

The preparation of the unhydrogenated nitrile-diene copolymers required as an intermediate for the hydrogenation can be effected by polymerization of the abovementioned monomers and has been described extensively in the literature (e.g. Houben-Weyl, Methoden der Organischen Chemie [Methods of Organic Chemistry], vol. 14/1, 30 Georg Thieme Verlag Stuttgart 1961) and is not particularly restricted. In general, the process is one in which α,β-ethylenically unsaturated nitrile units, conjugated diene units and optional further monomer units are copolymerized as desired. The polymerization process used may be any known emulsion polymerization process, suspension polymerization process, bulk polymerization process or solution polymerization process. Preference is given to the emulsion polymerization process. Emulsion polymerization is especially understood to mean a process known per se in which the reaction medium used is usually water (see, inter alia, Römpp Lexikon der Chemie [Römpp's Chemistry Lexicon], volume 2, 10th edition 1997; P. A. Lovell, M. S. El-Aasser, Emulsion Polymerization and Emulsion Polymers, John Wiley & Sons, ISBN: 0471 96746 7; H. Gerrens, Fortschr. Hochpolym. Forsch. 1, 234 (1959)). The incorporation rate of the termonomer can easily be adjusted by the person skilled in the art such that a terpolymer according to the invention is obtained. The monomers can be initially charged or reacted by incrementation in two or more steps.

Metathesis and/or Hydrogenation:

It is also possible for the production of the unhydrogenated nitrile-diene copolymer to be followed by a metathesis reaction for reduction of the molecular weight of the nitrile-diene copolymer or a metathesis reaction and a subsequent hydrogenation or a hydrogenation only. These metathesis or hydrogenation reactions are well known to those skilled in the art and are described in the literature. Metathesis is known, for example, from WO-A-02/100941 and WO-A-02/100905 and can be used to reduce the molecular weight.

(b) Polyamide

The polyamide in the vulcanizable composition according to the invention is preparable from a combination of diamine and dicarboxylic acid, from an w-aminocarboxylic acid or the corresponding lactam. In principle, it is possible to use any polyamide, preferably PA6, PA66, PA610, PA88, PA612, PA810, PA108, PA9, PA613, PA614, PA812, PA1010, PA10, PA814, PA148, PA1012, PA11, PA1014, PA1212 or PA12.

Particular preference is given to nylon-6 (PA6) or nylon-6,6 (PA66), very particular preference to using nylon-6.

Polyamides preferred in accordance with the invention are semicrystalline or amorphous polyamides that are preparable proceeding from diamines and dicarboxylic acids and/or lactams having at least 5 ring members or corresponding amino acids.

Useful reactants are preferably aliphatic and/or aromatic dicarboxylic acids, more preferably adipic acid, 2,2,4-trimethyladipic acid, 2,4,4-trimethyladipic acid, azelaic acid, sebacic acid, isophthalic acid, terephthalic acid, aliphatic and/or aromatic diamines, more preferably tetramethylenediamine, pentamethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bis(aminomethyl)cyclohexane, phenylenediamines, xylylenediamines, aminocarboxylic acids, especially aminocaproic acid, or the corresponding lactams. Copolyamides of a plurality of the monomers mentioned are included.

Polyamide suitable in accordance with the invention is known, for example, by the Durethan® or Nylon® brand name. Most preferably, Durethan® B31F PA 6 from LANXESS is used.

It is of course also possible to use mixtures of these polyamides, where the mixing ratio is as desired.

Proportions of recycled polyamide molding materials and/or fibre recyclates may also be present.

The polyamides preferably have a relative viscosity of 2.3 to 4.0, more preferably of 2.7 to 3.5, where the relative viscosity can be determined/measured on a 1% by weight solution in m-cresol at 25° C.

The preparation of the polyamides is prior art. Of course, it is alternatively possible to use copolyamides based on the abovementioned polyamides.

A multitude of procedures for preparation of polyamides has become known, with use, depending on the desired end product, of different monomer units and various chain transfer agents to establish a desired molecular weight or else monomers with reactive groups. The industrially relevant processes for preparing the polyamides for use in the substance mixture preferably proceed via polycondensation in the melt. In this context, the hydrolytic polymerization of lactams is also considered to be polycondensation. The preparation of polyamides by thermal polycondensation is known to those skilled in the art; see, inter alia, Nylon Plastics Handbook, Hanser-Verlag Munich 1995, pages 17-27, and Kunststoff-Handbuch [Plastics Handbook] 3/4, Polyamide [Polyamides], Carl Hanser Verlag, Munich 1998, pages 22-36.

Especially preferred are random, semicrystalline, aliphatic PA 6/66 copolyamides, polymerized from ε-caprolactam and hexamethylenediamine adipate.

ε-Caprolactam (CAS number 105-60-2) is used with preference for preparation of polyamide inter alia. Cyclohexanone oxime is first prepared from cyclohexanone by reaction with the hydrogensulfate or the hydrochloride of hydroxylamine. This cyclohexanone oxime is converted to ε-caprolactam by a Beckmann rearrangement.

Hexamethylenediamine adipate (CAS number 3323-53-3) is the reaction product of adipic acid and hexamethylenediamine. One of its uses is as an intermediate in the preparation of nylon-6,6. The trivial name AH salt derives from the initial letters of the starting substances.

It is likewise also possible to use mixtures of different polyamides, provided that they are sufficiently compatible. Compatible combinations of polyamides are known to those skilled in the art. Polyamide combinations for use with preference are PA6/PA66, PA12/PA1012, PA12/1212, PA612/PA12, PA613/PA12, PA1014/PA12 or PA610/PA12 and corresponding combinations with PA11, more preferably PA6/PA66. In the case of doubt, compatible combinations can be ascertained by routine experiments.

Instead of aliphatic polyamides, it is advantageously also possible to use a semiaromatic polyamide wherein the dicarboxylic acid component originates to an extent of 5 to 100 mol % from aromatic dicarboxylic acid having 8 to 22 carbon atoms and which preferably has a crystallite melting point Tₘ to ISO 11357-3 of at least 250° C., more preferably of at least 260° C. and especially preferably of at least 270° C. Polyamides of this kind are typically identified by the addition T (=semiaromatic). They are preparable from a combination of diamine and dicarboxylic acid, optionally with addition of an ω-aminocarboxylic acid or a corresponding lactam. Suitable types are preferably PA66/6T, PA6/6T, PA6T/MPMDT (MPMD stands for 2-methylpentamethylenediamine), PA9T, PA10T, PA11T, PA12T, PA14T and copolycondensates of these latter types with an aliphatic diamine and an aliphatic dicarboxylic acid or with an ω-aminocarboxylic acid or a lactam. The semiaromatic polyamide can also be used in the form of a blend with another, preferably aliphatic, polyamide, more preferably with PA6, PA66, PA11 or PA12.

Another suitable polyamide class is that of transparent polyamides; these are amorphous in most cases, but may also be microcrystalline. They can be used either on their own or in a mixture with aliphatic and/or semiaromatic polyamides, preferably PA6, PA66, PA11 or PA12. The glass transition point Tg, measured to ISO 11357-3, is at least 110° C., preferably at least 120° C., more preferably at least 130° C. and more preferably at least 140° C. Preferred transparent polyamides are the polyamide of dodecane-1,12-dioic acid and 4,4′-diaminodicyclohexylmethane (PAPACM12), especially proceeding from a 4,4′-diaminodicyclohexylmethane having a trans,trans isomer content of 35% to 65%, the polyamide of terephthalic acid and/or isophthalic acid and the isomer mixture of 2,2,4- and 2,4,4-trimethylhexamethylenediamine, the polyamide of isophthalic acid and hexamethylene-1,6-diamine, the copolyamide of a mixture of terephthalic acid/isophthalic acid and hexamethylene-1,6-diamine, optionally in a mixture with 4,4′-diaminodicyclohexylmethane, the copolyamide of terephthalic acid and/or isophthalic acid, 3,3′-dimethyl-4,4′-diaminodicyclohexylmethane from laurolactam or caprolactam, the (co)polyamide of dodecane-1,12-dioic acid or sebacic acid, 3,3′-dimethyl-4,4′-diaminodicyclohexylmethane and optionally laurolactam or caprolactam, the copolyamide of isophthalic acid, 4,4′-diaminodicyclohexylmethane and laurolactam or caprolactam, the polyamide of dodecane-1,12-dioic acid and 4,4′-diaminodicyclohexylmethane (with low trans,trans isomer content), the copolyamide of terephthalic acid and/or isophthalic acid and an alkyl-substituted bis(4-aminocyclohexyl)methane homologue, optionally in a mixture with hexamethylenediamine, the copolyamide of bis(4-amino-3-methyl-5-ethylcyclohexyl)methane, optionally together with a further diamine, and isophthalic acid, optionally together with a further dicarboxylic acid, the copolyamide of a mixture of m-xylylenediamine and a further diamine, e.g. hexamethylenediamine, and lsophthalic acid, optionally together with a further dicarboxylic acid, for example terephthalic acid and/or napthalene-2,6-dicarboxylic acid, the copolyamide of a mixture of bis(4-aminocyclohexyl)methane and bis-(4-amino-3-methyl-cyclohexyl)methane and aliphatic dicarboxylic acids having 8 to 14 carbon atoms, and polyamides or copolyamides formed from a mixture containing tetradecane-1,14-dioic acid and an aromatic, arylaliphatic or cycloaliphatic diamine.

These examples may be varied very substantially by addition of further components, preferably caprolactam, laurolactam or diamine/dicarboxylic acid combinations, or by partial or complete replacement of starting components with other components.

Lactams or ω-aminocarboxylic acids that are used as polyamide-forming monomers contain 4 to 19 and especially 6 to 12 carbon atoms. Particular preference is given to using ε-caprolactam, ε-aminocaproic acid, caprylolactam, ω-aminocaprylic acid, laurolactam, ω-aminododecanoic acid and/or ω-aminoundecanoic acid.

Combinations of diamine and dicarboxylic acid are, for example, hexamethylenediamine/adipic acid, hexamethylenediamine/dodecanedioic acid, octamethylenediamine/sebacic acid, decamethylenediamine/sebacic acid, decamethylenediamine/dodecanedioic acid, dodecamethylenediamine/dodecanedioic acid and dodecamethylenediamine/naphthalene-2,6-dicarboxylic acid. In addition, it is alternatively possible to use all other combinations, especially decamethylenediamine/dodecanedioic acid/terephthalic acid, hexamethylenediamine/adipic acid/terephthalic acid, hexamethylenediamine/adipic acid/caprolactam, decamethylenediamine/dodecanedioic acid/ω-aminoundecanoic acid, decamethylenediamine/dodecanedioic acid/laurolactam, decamethylenediamine/terephthalic acid/laurolactam or dodecamethylenediamine/naphthalene-2,6-dicarboxylic acid/laurolactam.

The ratio of HNBR rubber (a) to polyamide (b) in compositions according to the invention is 1:more than 0.01 to 1:0.15, preferably 1:0.05 to 1:0.1.

The amount of polyamide (b) in the vulcanizable compositions is 1 to 15 parts by weight, preferably 1 to 12.5 parts by weight, more preferably 2 to 12.5 parts by weight and most preferably 5 to 10 parts by weight, based on 100 parts by weight of HNBR rubber (a).

If the amount of polyamide is too small, i.e. less than 5 phr, no improvement in hot air ageing occurs, especially in the change in elongation at break and/or the change in tensile strength.

If the amount of polyamide is too high, i.e. greater than 10 phr, there is likewise no occurrence of sufficient improvement in hot air ageing, especially in the change of hardness, in the change in elongation at break and/or the change in tensile strength.

(c) Peroxidic Crosslinker

Examples of useful peroxidic crosslinkers include peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)hex-3-yne.

In a preferred embodiment, the composition according to the invention comprises at least one peroxidic crosslinker selected from dicumyl peroxide, 2,5-dimethyl-2,5-di-(tert-butylperoxy)hexane, 1,3-di(tert-butylperoxyisopropyl)benzene, 2,5-dimethyl-2,5-di-tert-butylperoxy(hexyne), preferably 1,3-di(tert-butylperoxyisopropyl)benzene.

In addition to these peroxidic crosslinkers it may be advantageous to use further additions which can help to increase the crosslinking yield: Suitable examples of these include triallyl isocyanurate, triallyl cyanurate, trimethylolpropane tri(meth)acrylate, triallyl trimellitate, ethylene glycol dimethacrylate, butanediol dimethacrylate, zinc diacrylate, zinc dimethacrylate, 1,2-polybutadiene or N,N″-m-phenylenebismaleimide.

The total amount of the peroxidic crosslinker(s) is typically in the range from 0.1 to 20 phr, preferably in the range from 1.5 to 15 phr and more preferably in the range from 2 to 10 phr, based on the HNBR rubber.

(d) Light-Coloured Fillers

The term “light-coloured fillers” is familiar to the person skilled in the art and sufficiently well known, for example from F. Röthemeyer/F. Sommer: Kautschuktechnologie [Rubber Technology], p. 262 ff., 2001, and include natural and synthetic light-coloured fillers, especially silicatic and/or oxidic fillers.

Synthetic light-coloured fillers are silicas (amorphous silicon dioxide) or silicates, especially calcium silicate, silanized calcium silicate, sodium aluminium silicate or aluminium silicate, silica, fumed silica, waterglass or surface-modified silicas.

Natural light-coloured fillers are, for example, siliceous earth, Neuburg siliceous earth, quartz flour, alumina, diatomaceous earth, bentonite, chalk (CaCO₃), kaolin, wollastonite (CaSiO₃) or talc.

Further light-coloured fillers are metal compounds, for example alkaline earth metal sulfates, especially barium sulfate, metal oxides, especially titanium dioxide, zinc oxide, calcium oxide, magnesium oxide, aluminium oxide (hydrate), iron oxide, alkaline earth metal carbonates, especially calcium carbonate, zinc carbonate or magnesium carbonate, metal hydroxides, especially aluminium hydroxide, aluminium oxyhydrate or magnesium hydroxide.

Light-coloured fillers in the context of the present invention are preferably basic silicatic or oxidic fillers, more preferably zinc oxide, magnesium oxide, sodium aluminium silicate, precipitated silica, silanized calcium silicate or calcined kaolin, and most preferably calcined kaolin, for example Polestar® 200 R, or silanized calcium silicate, for example Tremin® 283-600 VST.

(e) Ageing Stabilizers

The vulcanizable composition according to the invention also contains at least one ageing stabilizer, preferably phenolic ageing stabilizers, aminic ageing stabilizers or phosphites.

Suitable phenolic ageing stabilizers are alkylated phenols, styrenized phenol, sterically hindered phenols such as 2,6-di-tert-butylphenol, 2,6-di-tert-butyl-p-cresol (BHT), 2,6-di-tert-butyl-4-ethylphenol, 2,2′-methylenebis(6-tert-butyl)-p-cresol, poly(dicyclopentadiene-co-p-cresol), sterically hindered phenols containing ester groups, such as n-octadecyl beta-(4-hydroxy-3,5-di-tert-butylphenyl)propionate, sterically hindered phenols containing thioether groups, 2,2′-methylenebis(4-methyl-6-tert-Butylphenol) (BPH), 2-methyl-4,6-bis(octylsulfanylmethyl)phenol and sterically hindered thiobisphenols. In particularly suitable embodiments, two or more ageing stabilizers are also added, for example a mixture of 2,2′-methylenebis(6-tert-butyl)-p-cresol, poly(dicyclopentadiene-co-p-cresol) and 2-methyl-4,6-bis(octylsulfanylmethyl)phenol.

Suitable aminic ageing stabilizers are diaryl-p-phenylenediamine (DTPD), 4,4′-bis(1,1-dimethylbenzyl)diphenylamine (CDPA), octylated diphenylamine (ODPA), phenyl-a-naphthylamine (PAN), phenyl-beta-naphthylamine (PBN) or mixtures thereof, preferably those based on phenylenediamine. Example of phenylenediamines are N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) or N,N′-bis-1,4-(1,4-dimethylpentyl)-p-phenylenediamine (77PD).

Suitable phosphates are tris(nonylphenyl) phosphite or sodium hypophosphite. Preferred phosphite is sodium hypophosphite. The phosphites are generally used in combination with phenolic ageing stabilizers.

Further suitable ageing stabilizers are 2,2,4-trimethyl-1,2-dihydroquinoline (TMQ), 2-mercaptobenzimidazole (MBI), methyl-2-mercaptobenzimidazole (MMBI) or zinc methylmercaptobenzimidazole (ZMMBI).

Ageing stabilizers are used in vulcanizable compositions typically in amounts of 0 to 5 parts by weight, preferably 0.5 to 3 parts by weight, based on 100 parts by weight of the HNBR rubber.

Other Optional Components:

Optionally, the vulcanizable compositions according to the invention may additionally also comprise one or more additives and fibrous materials that are familiar to the person skilled in the art of rubbers. These include filler activators, reversion stabilizers, light stabilizers, antiozonants, processing auxiliaries, mould release agents, plasticizers, mineral oils, tackifiers, blowing agents, dyes, pigments, waxes, resins, extenders, carbon blacks, carbon nanotubes, graphene, Teflon (the latter preferably in powder form), vulcanization retardants, strengthening members (fibres) of glass, cord, fabric, fibres of polyesters and natural fibre products, salts of unsaturated carboxylic acids, for example zinc diacrylate (ZDA), zinc methacrylates (ZMA) and zinc dimethylacrylate (ZDMA), liquid acrylates, further rubbers or other additives that are known in the rubber industry (Ullmann's Encyclopedia of Industrial Chemistry, VCH Verlagsgesellschaft mbH, D-69451 Weinheim, 1993, vol A 23 “Chemicals and Additives”, p. 366-417).

Useful filler activators especially include organic silanes, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, surface-active substances such as triethanolamine and ethylene glycols having molecular weights of 74 to 10 000 g/mol. The amount of filler activators is typically 0 to 10 parts by weight based on 100 parts by weight of the HNBR rubber.

Further rubbers may optionally be present in an amount of not more than 30% by weight, preferably not more than 20% by weight, more preferably not more than 10% by weight, based on the total weight of the vulcanizable composition. A preferred further rubber is ethylene-vinyl acetate polymer (EVM).

The total amount of additives and fibrous materials is typically in the range from 1 to 300 parts by weight based on 100 parts by weight of the nitrile rubber.

In a preferred embodiment of the invention, the vulcanizable composition contains
(a) 100 parts by weight of HNBR rubber,
(b) 1 to 15 parts by weight of polyamide, preferably 1 to 12.5 parts by weight, more preferably 2 to 12.5 parts by weight and most preferably 5 to 10 parts,
(c) 0.1 to 20 parts by weight of peroxidic crosslinker,
(d) 0 to 300 parts by weight of light-coloured filler and
(e) 0 to 5 parts by weight of ageing stabilizer.

In a particularly preferred embodiment of the invention, the vulcanizable composition contains
(a) 100 parts by weight of HNBR rubber,
(b) 1 to 15 parts by weight of polyamide, preferably 1 to 12.5 parts by weight, more preferably 2 to 12.5 parts by weight and most preferably 5 to 10 parts,
(c) 0.5 to 10 parts by weight of peroxidic crosslinker,
(d) 10 to 120 parts by weight of light-coloured filler and
(e) 0.5 to 3 parts by weight of ageing stabilizer.

Process for Producing a Vulcanizable Composition Based on HNBR Rubber

The invention further provides a process for producing vulcanizable compositions based on HNBR rubber by mixing the HNBR rubber (a), the polyamide (b) and the peroxidic crosslinker (c), and optionally the light-coloured filler (d) and the ageing stabilizer (e), and the further components optionally present. This mixing operation can be effected in standard mixing equipment, for example internal mixers, Banbury mixers or rollers, with which a sufficiently high temperature can be established, such that the melting point of the polyamide can be attained. The sequence of metered addition is effected as described in process A.

Two possible procedural variants are set out hereinbelow by way of example:

Process A: Production of the PA/HNBR mixture in an internal mixer

Internal mixers having an intermeshing rotor geometry are preferred.

Prior to use, the polyamide is stored at 80° C. for 16 h. At the start time, the internal mixer is charged with the polyamide. After a suitable mixing period, the HNBR rubber and the ageing stabilizer are added. The mixing is effected under temperature control, with the proviso that the mixture remains at a temperature in the region of at least 230° C. for a suitable time. After a further suitable mixing period, the further mixture constituents are added, such as optionally the fillers, white pigments (for example titanium dioxide), dyes and other processing actives. After a further suitable mixing period, the internal mixer is vented and the shaft is cleaned. After a further suitable period of time, the internal mixer is emptied to obtain the vulcanizable mixture. Suitable periods of time are understood to mean a few seconds to a few minutes. The crosslinking chemicals may either be incorporated in a separate step on a roller, especially when mixing is performed at an elevated mixing temperature, or co-added directly in the internal mixer. It must be ensured in this case that the mixing temperature is well below the reaction temperature of the crosslinking chemicals. The mixture can thus be produced completely by method A (with complete addition of all components) or else by method A (without addition of the crosslinking chemicals) in combination with method B. Preference is given to the combination of methods A and B.

The vulcanizable mixtures thus produced can be assessed in a customary manner, for instance by Mooney viscosity, by Mooney scorch or by a rheometer test.

Process B: Production on a roller

If rollers are used as mixing units, the HNBR rubber-PA mixture produced by Method A is first applied to the roller. Once a homogeneous milled sheet has been formed the fillers, plasticizers and other additives with the exception of the crosslinking chemicals are added. After incorporation of all components, the crosslinking chemicals are added and incorporated. The mixture is then incised three times on the right and three times on the left and doubled over 5 times. The finished milled sheet is rolled to the desired thickness and subjected to further processing according to the desired test methods.

Process for Producing Vulcanizates Based on HNBR Rubber

The invention further provides the process for producing vulcanizates according to the invention, preferably as mouldings, characterized in that the vulcanizable composition comprising components (a), (b), (c), optionally (d) and optionally (e) and optionally further components is subjected to a vulcanization, preferably in a moulding process and more preferably at temperatures in the range from 100° C. to 250° C., more preferably at temperatures in the range from 120° C. to 250° C. and most preferably temperatures in the range from 130° C. to 250° C. For this purpose, the vulcanizable composition is subjected to further processing with calendars, rolls or extruders. The preformed mass is then vulcanized in presses, autoclaves, hot air systems or in what are called automatic mat vulcanization systems (“Auma”), and preferred temperatures have been found to be in the range from 100° C. to 250° C., —particularly preferred temperatures in the range from 120° C. to 250° C. and very particularly preferred temperatures in the range from 130° C. to 250° C. The vulcanization time is typically 1 minute to 24 hours and preferably 2 minutes to 1 hour. Depending on the shape and size of the vulcanizates, a second vulcanization by reheating may be necessary in order to achieve complete vulcanization.

The invention further provides the thus obtainable vulcanizates thus obtainable, based on vulcanizable compositions according to the invention.

The invention also provides for the use of the vulcanizates based on vulcanizable compositions according to the invention for production of mouldings, preferably for production of mouldings selected from the group consisting of belts, gaskets, cover panels, rollers, footwear components, hoses, damping elements, stators, cable sheaths and packer elements, more preferably belts and gaskets.

The invention thus provides vulcanizates as mouldings based on vulcanizable compositions according to the invention that are preferably selected from belts, gaskets, cover panels, rollers, footwear components, hoses, damping elements, stators, cable sheaths and packer elements, more preferably belts and gaskets. The methods usable by way of example for this purpose, such as moulding, injection moulding or extrusion methods and the corresponding injection moulding apparatuses or extruders, are sufficiently well-known to the person skilled in the art. In the production of these mouldings, it is possible to supplement the vulcanizable compositions according to the invention with the aforementioned standard auxiliaries which are known to those skilled in the art and have to be suitably selected using customary art knowledge, for example filler activators, accelerators, crosslinkers, antiozonants, processing oils, extender oils, plasticizers, activators or scorch inhibitors.

The particular advantage of the invention is that the vulcanizable compositions according to the invention based on HNBR rubber are suitable for production of vulcanizates having improved hot air resistance, i.e. having a small change in tensile strength and/or elongation at break.

### EXAMPLES

Test Methods:

For the tensile testing, 2 mm sheets were produced by vulcanization of the vulcanizable mixture at 180° C. The dumbbell-shaped test specimens were punched out of these sheets and tensile strength and elongation were determined to DIN 553504.

Hardness was determined with a durometer to DIN-ISO 7619.

Compression set (CS) was determined to DIN ISO 850 Part A.

Ageing characteristics of the vulcanizates were determined to DIN 53508.

The Following Substances were Used in the Examples:

The following chemicals were purchased as commercial products from the companies specified in each case or originate from production plants of the companies specified.

Substances Used in the Vulcanizable Composition:

| | |
|---|---|
| Therban ® 3907 | HNBR rubber; 39 ± 1.5% by weight of acrylonitrile (ACN), |
| | residual double bond content (RDB) ≤ 0.9%; Mooney |
| | viscosity 70 MU; volatiles ≤ 0.5% by weight (ARLANXEO) |
| Therban ® LT 2007 | HNBR rubber (acrylate terpolymer), 21 ± 1.5% by weight of |
| | acrylonitrile (ACN), residual double bond content (RDB) ≤ |
| | 0.9%; Mooney viscosity 74 MU; volatiles ≤ 0.49% by |
| | weight (ARLANXEO) |
| Durethan ® B 31 F | PA6 polyamide (LANXESS) |
| Perkadox ® 14-40 | di(tert-butylperoxyisopropyl)benzene 40% supported on |
| | silica; peroxidic crosslinker (Akzo Nobel Polymer |
| | Chemicals) |
| Vulkasil ® A1 | sodium aluminium silicate having a pH in water (5% by |
| | weight in water) measured according to DIN ISO 787/9 of |
| | 11.3 ± 0.7, a content of volatile constituents measured |
| | according to DIN ISO 787/2 of 5.5 ± 1.5 and a surface |
| | area (BET) measured according to ISO 9277 of 65 ± 15 |
| | (LANXESS) |
| Aktifit ® VM | activated Silfit ® Z91 (= natural mixture of corpuscular |
| | silica and lamellar kaolinite), light-coloured filler |
| | (Hoffmann Mineral) |
| Polestar ® 200R | calcined kaolin containing 55% by weight of SiO₂, 41% by |
| | weight of Al₂O₃, having a pH of 6.5 ± 0.5 and a surface |
| | area (BET) of 8.5 m²/g, light-coloured filler (Imerys) |
| Vulkanox ® HS/LG | 2,2,4-trimethyl-1,2-dihydroquinoline polymer (TMQ), |
| | lenticular granules (LG), ageing stabilizer (LANXESS) |
| Luvomaxx ® CDPA | 4,4′-bis(1,1-dimethylbenzyl)diphenylamine, ageing |
| | stabilizer (Lehmann und Voss) |
| Antilux ® 110 | mixture of paraffins and microwaxes with moderately |
| | broad molecular weight distribution; antiozonant wax |
| | (LANXESS) |
| Vulkanox ® MB2 | 4- and 5-methyl-2-mercaptobenzimidazole, ageing |
| | stabilizer (LANXESS) |
| Uniplex ® 546 | trioctyl trimellitate (TOTM), plasticizer (LANXESS) |
| Maglite ® DE | magnesium oxide (CP Hall) |
| Lithium carbonate | Li₂CO₃ |
| Sodium hypophosphite* H₂O | NaH₂PO₂ ageing stabilizer |
| TAIC 70% | KETTLITZ-TAIC 70; co-agent; (Kettlitz-Chemie) |

Production of the Vulcanizable Composition

Prior to use, the polyamide was stored at 80° C. for 16 h. At the start time, the internal mixer was charged with the polyamide. Prior to addition, the internal mixer was heated to 200° C. and, after addition, brought to at least the melting temperature of the polyamide, 230° C. in this case, by adjusting the rotor speed. After one minute, the HNBR rubber and the ageing stabilizer were added. The mixing was effected under temperature control, with the proviso that the mixture remained at a temperature in the region of at least 230° C. for 10 minutes. Thereafter, the further mixture constituents except for the co-agent and the peroxide were added. After one minute, the internal mixer was vented and the shaft was cleaned. Thereafter, the internal mixer was emptied to obtain the mixture.

After the mixture had been cooled to room temperature, it was applied to a roller unit. The diameter of the counter-rotating rollers was 200 mm, the length 450 mm. The rollers were preheated to 40° C. The speed of the front roller was 20 rpm, and that of the rear roller 22 rpm, such that they ran with a friction of 1:1.1. Once a homogeneous milled sheet had formed, the crosslinking chemicals were added and mixed in. The mixture was then incised three times on the right and three times on the left and doubled over 5 times. The finished milled sheet was rolled to the desired thickness and subjected to further processing according to the desired test methods.

Production of the Vulcanizates

The vulcanization characteristics of the vulcanizable mixture produced by the above process are ascertained by means of a moving die rheometer (MDR). Measurement is conducted at 180° C., and indices familiar to the person skilled in the art, such as scorch time, t95 and Smax are ascertained.

The aforementioned vulcanizable compositions are subjected to a thermal treatment. The duration of this treatment corresponds to the t95 ascertained in the MDR.

The vulcanizable compositions according to the invention are subjected to a temperature of 180° C. in suitable moulds (compression vulcanization).

In the course of crosslinking of the vulcanizable composition according to the invention, the peroxide compounds (c) lead to free-radical crosslinking between and with the hydrogenated nitrile rubbers (a) used.

All figures given in the tables in “phr” mean parts per hundred of rubber. The sum total of all the elastomer components comprising an HNBR corresponds to 100 phr.

TABLE 1
Composition of the vulcanizable compositions A1 to A6

| | V1 | P1 | P2 | P3 | P4 | P5 | P6 | V2 |
|---|---|---|---|---|---|---|---|---|
| | phr | phr | phr | phr | phr | phr | phr | phr |
| (a) Therban ® 3907 | 100 | 100 | 100 | 100 | 100 | 100 | 100 | 100 |
| (b) Durethan ® B 31 F | 0 | 1 | 2 | 5 | 10 | 12.5 | 15 | 22 |
| (c) Perkadox ® 14-40 | 6 | 6 | 6 | 6 | 6 | 6 | 6 | 6 |
| (d) Polestar ® 200 R | 37 | 15 | 15 | 15 | 15 | 15 | 15 | 15 |
| (d) Maglite ® DE | 5 | 5 | 5 | 5 | 5 | 5 | 5 | 5 |
| (e) Luvomaxx ® CDPA | 1.2 | 1.2 | 1.2 | 1.2 | 1.2 | 1.2 | 1.2 | 1.2 |
| (e) Vulkanox ® MB2 | 0.3 | 0.3 | 0.3 | 0.3 | 0.3 | 0.3 | 0.3 | 0.3 |
| Antilux ® 110 | 0.5 | 0.5 | 0.5 | 0.5 | 0.5 | 0.5 | 0.5 | 0.5 |
| TAIC 70% | 1.4 | 1.4 | 1.4 | 1.4 | 1.4 | 1.4 | 1.4 | 1.4 |

TABLE 1.1
Composition of the vulcanizable compositions P A3 and P A4

| | P4.1 | P4.2 |
|---|---|---|
| | phr | phr |
| (a) Therbane ® 3907 | 100 | 100 |
| (b) Durethan ® B 31 F | 10 | 10 |
| (c) Perkadox ® 14-40 | 6 | 6 |
| (d) Polestar ® 200 R | 15 | 15 |
| (d) Maglite ® DE | 5 | 5 |
| (e) Luvomaxx ® CDPA | 1.2 | 1.2 |
| (e) Vulkanox ® MB2 | 0.3 | 0.3 |
| (e) Lithium carbonate | 2.5 | |
| (e) NaH₂PO₂ * H₂O | | 3.0 |
| Antilux ® 110 | 0.5 | 0.5 |
| TAIC 70 % | 1.4 | 1.4 |

TABLE 2
Composition of the vulcanizable compositions B1

| | V B1 | P B1 |
|---|---|---|
| | phr | phr |
| (a) Therban ® LT 2007 | 100 | 100 |
| (b) Durethan ® B 31 F | 0 | 7 |
| (c) Perkadox ® 14-40 | 8 | 8 |
| (d) Vulkasil ® A1 | 20 | 20 |
| (d) Aktifit ® VM | 80 | 80 |
| (d) Maglite ® DE | 5 | 5 |
| (e) Vulkanox ® HS | 1.5 | 1.5 |
| (e) Vulkanox ® MB2 | 0.3 | 0.3 |
| Uniplex ® 546 | 10 | 10 |
| TAIC 70% | 1.4 | 1.4 |

TABLE 3
Vulcanization properties (MDR 180° C.; 20 min)

| | | V1 | P1 | P2 | P3 | P4 | P5 | P6 | V2 |
|---|---|---|---|---|---|---|---|---|---|
| ML(1 + 4)100° C. | MU | 83 | 72 | 73 | 74 | 84 | 86 | 108 | 84 |
| S′ min (MDR at | dNm | 1.0 | 0.8 | 0.8 | 0.9 | 1.0 | 1.0 | 1.6 | 1.1 |
| 180° C.) | | | | | | | | | |
| S′ max | dNm | 16.0 | 13.3 | 13.1 | 15.1 | 16.9 | 14.8 | 19.6 | 17.5 |
| S′ max-S′ min | dNm | 15.0 | 12.5 | 12.4 | 14.3 | 15.8 | 13.8 | 18.0 | 16.4 |
| t95 | s | 439 | 462 | 428 | 439 | 429 | 430 | 426 | 445 |

TABLE 3.1
Vulcanization properties (MDR 180° C.; 20 min)

| | | V B1 | P BI |
|---|---|---|---|
| ML(1 + 4) 100° C. | MU | 88.73 | 76.38 |
| S' min (MDR at 180° C.) | dNm | 1.85 | 1.47 |
| S' max | dNm | 21.56 | 22.51 |
| S' max-S' min | dNm | 19.71 | 21.04 |
| t95 | s | 446 | 429 |

TABLE 4
Properties of the unaged vulcanizates

| | | V1 | P1 | P2 | P3 | P4 | P5 | P6 | V2 |
|---|---|---|---|---|---|---|---|---|---|
| H | ShA | 58 | 53 | 54 | 56 | 59 | 58 | 67 | 61 |
| E@B | % | 502 | 482 | 486 | 464 | 400 | 371 | 389 | 358 |
| TS | MPa | 23.9 | 21.2 | 18.8 | 22.8 | 19.1 | 15.4 | 23.8 | 19.0 |
| M100 | MPa | 2.2 | 1.4 | 1.5 | 1.6 | 2.5 | 2.1 | 4.7 | 3.0 |
| CS (24 h/150° C.) | % | 23 | 31 | 26 | 20 | 20 | 31 | 27 | 20 |
| CS (168 h/150° C.) | % | | | | 37 | 36 | | 44 | |

TABLE 4.1
Properties of the unaged vulcanizates

| | | P4.1 | P4.2 | V B1 | P B1 |
|---|---|---|---|---|---|
| H | ShA | 60 | 60 | 68 | 69 |
| E @ B | % | 483 | 440 | 239 | 201 |
| TS | MPa | 20.5 | 14.4 | 17.4 | 14.1 |
| M100 | MPa | 4.3 | 4 | 6.4 | 7.4 |
| CS (24 h/150° C.) | % | 27 | 28 | 14 | 17 |
| CS (168 h/150° C.) | % | 41 | 42 | 36 | 38 |

TABLE 5
Properties of the aged vulcanizates after ageing at 170° C.

| | | V1 | P1 | P2 | P3 | P4 | P5 | P6 | V2 |
|---|---|---|---|---|---|---|---|---|---|
| Ageing | | | | | | | | | |
| for | | | | | | | | | |
| 336 h | | | | | | | | | |
| H | ShA | 69 | 63 | 63 | 64 | 67 | 66 | 74 | 69 |
| ΔH | ShA | 11 | 10 | 9 | 8 | 8 | 8 | 7 | 8 |
| E@B | % | 365 | 479 | 474 | 467 | 475 | 462 | 429 | 420 |
| TS | MPa | 15.9 | 20.9 | 17.5 | 20.2 | 19.3 | 14.2 | 16.8 | 13.4 |
| M100 | MPa | 6.7 | 3.1 | 3 | 3.6 | 4.4 | 3.6 | 6.2 | 4.8 |
| ΔE@B | % | −27 | −1 | −2 | 1 | 19 | 25 | 10 | 17 |
| ΔTS | % | −33 | 20.9 | 17.5 | −11 | 1 | −7.8 | −29 | −29 |
| ΔM100 | % | 205 | | | 125 | 76 | | 32 | 60 |
| Ageing | | | | | | | | | |
| for | | | | | | | | | |
| 504 h | | | | | | | | | |
| H | ShA | 73 | 65 | 64 | 66 | 69 | 68 | 75 | 71 |
| ΔH | ShA | 15 | 12 | 11 | 11 | 11 | 9 | 8 | 10 |
| E@B | % | 176 | 363 | 380 | 369 | 389 | 352 | 379 | 293 |
| TS | MPa | 15.9 | 14.2 | 14 | 15.2 | 16.3 | 11 | 14.7 | 12.6 |
| M100 | MPa | 12.4 | 4.4 | 4.1 | 4.8 | 5.6 | 4.4 | 6.8 | 6.2 |
| ΔE@B | % | −65 | −25 | −22 | −20 | −3 | −5 | −3 | −18 |
| ΔTS | % | −33 | −33 | −25.5 | −33 | −15 | −28.6 | −38 | −34 |

TABLE 5.1
Properties of the aged vulcanizates after ageing at 170° C.

| | | P4.1 | P4.2 | V B1 | P B1 |
|---|---|---|---|---|---|
| Ageing for 336 h | | | | | |
| H | ShA | 69 | 65 | 82 | 83 |
| ΔN | ShA | 9 | 5 | 14 | 14 |
| E @ B | % | 524 | 454 | 143 | 145 |
| TS | MPa | 16.1 | 13.8 | 16.1 | 13.3 |
| M100 | MPa | 4.2 | 3.6 | 13.3 | 12 |
| ΔE @ B | % | 8 | 3 | −40 | −28 |
| ΔTS | % | −21.5 | −4.2 | −7 | −6 |
| ΔM100 | % | −2.3 | −10.0 | 108 | 62 |
| Ageing for 504 h | | | | | |
| H | ShA | 70 | 66 | | |
| ΔH | ShA | 10 | 6 | | |
| E @ B | % | 431 | 321 | | |
| TS | MPa | 12.4 | 10.4 | | |
| M100 | MPa | 5.3 | 4.3 | | |
| ΔE @B | % | −11 | −27 | | |
| ΔTS | % | −39.5 | −27.8 | | |

TABLE 6
Properties of the aged vulcanizates after ageing at 180° C.

| Ageing | | | | | | | | | |
|---|---|---|---|---|---|---|---|---|---|
| for | | | | | | | | | |
| 336 h | | V1 | P1 | P2 | P3 | P4 | P5 | P6 | V2 |
| H | ShA | 85 | 69 | 66 | 67 | 66 | 68 | 67 | 87 |
| ΔH | ShA | 24 | 16 | 12 | 11 | 9 | 10 | 9 | 16 |
| E@B | % | 2 | 124 | 152 | 185 | 243 | 169 | 149 | 2 |
| TS | MPa | 7.5 | 10.3 | 9.1 | 9.4 | 10.1 | 9.1 | 8.7 | 4.9 |
| M100 | MPa | — | 8.3 | 6.8 | 5.9 | 5.5 | 6.6 | 6.8 | — |
| ΔE@B | % | −99 | −74 | −69 | −57 | −47 | −54 | −64 | −99 |
| ΔTS | % | −58.1 | −51.4 | −51.6 | −31.9 | −51.9 | −40.9 | −54.7 | −78.3 |

The vulcanizates according to the invention contain 5 to 10 phr polyamide (b) and, after hot air ageing at 170° C. for 2 or 3 weeks (336 hours or 504 hours), have a smaller change in tensile strength and/or a smaller change in elongation at break. Vulcanizates without polyamide (V1 or V B1) have a greater change in tensile strength and elongation at break that vulcanizates with polyamide (P1, P2, P3, P4, P5, P6, and P4.1, P4.2 and P B1).

Vulcanizates having 15 phr or more polyamide (V2) do have a smaller change than vulcanizates without polyamide (V1). However, the change in tensile strength or in elongation at break or in both is much greater and hence worse than the vulcanizates according to the invention with only 5 to <15 phr polyamide.

After hot ageing at 170° C. for 504 hours, the vulcanizate P4 with 10 phr polyamide has both the smallest change in elongation at break (ΔEB) and the smallest change in tensile strength (ΔTS), comparative vulcanizates without polyamide (V1) and vulcanizates with too much polyamide (V2).

After hot ageing at 180° C. for 336 hours, the inventive vulcanizates P1 to P6 with 1 to 15 phr polyamide have smaller changes in elongation at break (ΔEB) and smaller changes in tensile strength (ΔTS) than vulcanizates without polyamide (V1) and vulcanizates with more than 15 phr polyamide (V2).

Comparison of the vulcanizates V B1 and P B1 shows that, even in the case of vulcanizates based on acrylate-containing HNBR terpolymers, an addition of small amounts of polyamide of just 7 phr leads to a significant improvement in hot air ageing, especially to a decrease in the change in elongation at break and in tensile strength.

1. Vulcanizable composition comprising:
(a) HNBR rubber,
(b) polyamide 6,
(c) peroxidic crosslinker,
(d) optionally light-coloured filler and
(e) optionally ageing stabilizer,
where the ratio of (a) to (b) is 1:0.01 to 1:0.15.

2. Vulcanizable composition according to claim 1, comprising:
(a) 100 parts by weight of hydrogenated HNBR rubber,
(b) 1 to 15 parts by weight of polyamide 6,
(c) 0.1 to 20 parts by weight of peroxidic crosslinker,
(d) 0 to 300 parts by weight of light-coloured filler and
(e) 0 to 5 parts by weight of ageing stabilizer.

3. Vulcanizable composition according to claim 1, wherein the HNBR rubber (a) contains 20% to 40% by weight of acrylonitrile units, 20% to 80% by weight of butadiene units and 0% to 60% by weight of a further copolymerizable monomer.

4. (canceled)

5. Vulcanizable composition according to claim 1, wherein the peroxidic crosslinker (c) is dicumyl peroxide, 2,5-dimethyl-2,5-di-(tert-butylperoxy)hexane, or 1,3-di(tert-butylperoxyisopropyl)benzene, 2,5-dimethyl-2,5-di-tert-butylperoxy(hexyne).

6. Vulcanizable composition according to claim 1, wherein the light-coloured filler (d) is zinc oxide, magnesium oxide, sodium aluminium silicate, precipitated silica, silanized calcium silicate or calcined kaolin.

7. Vulcanizable composition according to claim 1, wherein the ageing stabilizer (e) is diaryl-p-phenylenediamine (DTPD), 4,4′-bis(1,1-dimethylbenzyl)diphenylamine (CDPA), octylated diphenylamine (ODPA), 2,2,4-trimethyl-1,2-dihydroquinoline (TMQ), 2-mercaptobenzimidazole (MBI), methyl-2-mercaptobenzimidazole (MMBI) or zinc methylmercaptobenzimidazole (ZMMBI).

8. Vulcanizable composition according to claim 1, comprising:
(a) 100 parts by weight of HNBR rubber,
(b) 1 to 15 parts by weight of polyamide 6,
(c) 0.5 to 10 parts by weight of peroxidic crosslinker,
(d) 10 to 120 parts by weight of light-coloured filler and
(e) 0.5 to 3 parts by weight of ageing stabilizer.

9. Process for producing a vulcanizable composition according to claim 1, said process comprising mixing components (a), (b), (c), (d) and (e).

10. Process for producing a vulcanizate based on HNBR rubber, said process comprising vulcanizing the vulcanizable composition according to claim 1, optionally in a shaping process, and optionally at a temperature in the range from 100° C. to 250° C.

11. Vulcanizate obtainable by the process according to claim 10.

12. Vulcanizate according to claim 11, which is a molding selected from the group consisting of belts, gaskets, cover panels, rollers, footwear components, hoses, damping elements, stators, cable sheaths and packer elements.
